(19) United States
(12) Patent Application Publication
(10) Pub. No.: US 2012/0001923 A1
(43) Pub. Date: Jan. 5, 2012

(54) SOUND-ENHANCED EBOOK WITH SOUND EVENTS TRIGGERED BY READER PROGRESS

(76) Inventors: Sara Weinzimmer, Mont Vernon, NH (US); Russ Weinzimmer, Milford, NH (US)

(21) Appl. No.: 12/830,305

(22) Filed: Jul. 3, 2010

(51) Int. Cl. G06F 17/00; G06F 3/041; G06T 13/00

(52) U.S. Cl. 345/473; 700/94; 345/173

(57) ABSTRACT

A sound-enhanced ebook is disclosed, the sound being presented to a reader of the ebook in accordance with the reader's progress through the ebook. The sound-enhanced ebook includes text information, and a plurality of sound events, each sound event being played in response to a reader's progress through particular text information associated with the sound event. Also disclosed is an ebook presenter for presenting text and coordinated sound events of a sound-enhanced ebook to a reader, the sound events being presented as the reader progresses through particular text of the ebook. The ebook presenter includes a text presentation module, a reader progress module, and a sound event presentation module, each sound event being associated with particular text information of the ebook, and each sound event being presentable in response to the reader's progress through the text information of the ebook as estimated by the reader progress module.

### FIELD OF THE INVENTION

This invention generally relates to ebooks (electronic books), and more particularly to ebooks with sound.

### BACKGROUND OF THE INVENTION

Books printed on paper are well-known. A more recent development has been to render the text of a book in electronic form. This is now referred to as an “ebook” (electronic book). Ebooks can be read on a general purpose computer, or on a specialized computer called an “ebook reader,” or an ebook presentation device.

Ebook readers, such as the KINDLE™, sold by Amazon.com, now include software that can synthesize speech. In fact, the Kindle can be instructed to “read” the ebook out loud automatically.

The Kindle also can play .mp3 sound files, such as “audio books”, i.e., books that have been read aloud by a human reader, recorded, and stored as an .mp3 file for listening on an .mp3 player. The Kindle can also play an .mp3 sound file so as to provide pleasant continuous background music to be enjoyed while reading an ebook.

### SUMMARY OF THE INVENTION

One general aspect of the invention is a sound-enhanced ebook, the sound being presentable to a reader of the ebook in accordance with the reader's progress through the ebook. The sound-enhanced ebook includes text information and a plurality of sound events. Each sound event is associated with particular text of the text information, and each sound event is presentable in response to a reader's progress through the text information.

In a preferred embodiment, each sound event is associated with at least one start trigger that starts playing the sound event when the reader's progress reaches text associated with the start trigger. In a further preferred embodiment, the start trigger depends on a speed of the reader's progress through the text information, the start trigger playing an associated sound event only if the speed is less than a speed threshold of the start trigger.

In a preferred embodiment, each sound event is associated with an end trigger that ends playing of the sound event when the reader's progress reaches text associated with the end trigger.

In another preferred embodiment, each sound event is associated with a sound duration. In a further preferred embodiment, the sound duration depends on a speed of the reader's progress through the text information.

In another preferred embodiment, the reader's progress through the text information is represented by a point moving through the text information, the approximate position of the point being calculated using a computation of the reader's reading speed, and an output of a timer.

In another preferred embodiment, the reader's progress through the text information is determined using an eye-tracking device.

In preferred embodiments, the ebook further includes, along with the text information, at least one of: graphical information, video information, hypertext information, definitional information, and citation information.

Another general aspect of the invention is an ebook presenter for presenting content of an ebook to a reader along with coordinated sound events, the sound events being presented as the reader progresses through the ebook. The ebook presentation device includes: a text presenter module capable of presenting at least text information of an ebook via a display; a reader progress module capable of determining at least an estimate of the reader's progress through the text information of the ebook; and a sound presentation module capable of playing sound events via a sound generator, each sound event being associated with particular text information of the ebook, each sound event being presentable in response to the reader's progress through the text information of the ebook as at least estimated by the reader progress module.

In a preferred embodiment, the reader progress module includes an eye-tracking device.

In another preferred embodiment, the reader progress module receives signals from at least one of: a reading start detector; a reading stop detector; a reader progress estimator; a touch screen; an eye tracker module; and a page turn detector. In a further preferred embodiment, the reader progress module provides a selectably visible reader progress cursor.

In yet another preferred embodiment, the reader progress module receives signals from a reader progress estimator, the reader progress estimator determining at least an estimate of the reader's progress through the text information of the ebook using a timer and at least an estimate of the reader's reading speed. In a further preferred embodiment, the estimate of the reader's reading speed is recalculated after each page-turn event.

In an additional preferred embodiment, the sound presentation module can play a sound event in response to the reader's progress reaching a start trigger of the sound event. In a preferred embodiment, the sound presentation module stops playing the sound event in response to the reader's progress reaching an end trigger. In an alternate preferred embodiment, the sound presentation module stops playing the sound event in response to the sound event playing for a period of time at least as long as a sound duration of the sound event.

In a preferred embodiment, the reader progress module can receive input from a touch screen allowing a reader to touch an ebook page at a particular position to indicate at least one of: where reading is to commence; where reading is to pause; where reading is to stop; and at least approximately which line of text is being read by the reader.

In another preferred embodiment, the reader progress module is capable of determining a reader's personal reading pace during a preliminary calibration step by measuring how long it takes for the reader to read a known reading sample.

In another preferred embodiment, the reader progress module computes an estimated current progress position within a page using page turn rate information and timer information.

Another general aspect of the invention is an ebook presentation device for presenting content of an ebook to a reader along with coordinated sound events, the sound events being presented as the reader progresses through the ebook. The ebook presentation device includes: a text presenter module capable of presenting text information of an ebook to a reader by streaming the ebook content via a text streaming window; and a sound presentation module capable of playing sound events, each sound event being associated with particular text of the text information of the ebook, each sound event starting to play while inside the text streaming window.

In a preferred embodiment, the height and width of the text streaming window can be set by the user according to preference.

In another preferred embodiment, a rate of text streaming is settable by the reader.

In another preferred embodiment, the sound event duration of a sound event can depend on the rate of text streaming, such that a sound event triggered during a rapid rate of text streaming has a shorter sound event duration than a sound event triggered during a slow rate of text streaming.

### BRIEF DESCRIPTION OF THE DRAWING

The invention will be more fully understood from the following detailed description, in conjunction with the following figures, wherein:

FIG. 1 is a schematic representation of a sound-enhanced e-book with sound events triggered by reader progress;

FIG. 2 is a representation of a page of the ebook of FIG. 1 having text, sound events, and a visible progress cursor;

FIG. 3 is an ebook presenter for presenting content of an ebook of FIG. 1;

FIG. 4 is a schematic representation of a sound event and related parameters;

FIG. 5 is a schematic representation of a sequence of pages of text of an ebook, and a text streaming window for presenting only a portion of that sequence of pages at each of a sequence of times, each portion possibly including at least one sound event;

FIG. 6 is a schematic representation of a page of an ebook having text, a picture, a video clip, a definition pop-up window, a citation pop-up window, and a hyperlink; and

FIG. 7 is a functional block diagram of an embodiment of the ebook presenter of FIG. 3.

### DETAILED DESCRIPTION

Music, sound effects, environmental sounds, and other sounds have been used effectively and powerfully to set mood and/or tone in movies, plays, and documentaries, for example. Such sounds substantially affect a viewer's emotional reaction to the presentation, and often color the meaning and increase the enjoyment of the entire work. Augmenting video and graphics with sound has been commonplace for decades; “the talkies” were a great leap forward from silent movies.

When a person reads a book, one typically imagines visual scenes inspired or informed by the author's writing. Adding sound further enhances the reader's experience in a way that just describing sound cannot approach, because real sound impacts different portions of the brain, thereby enhancing the meaning and effect of the written words. It is said that “a picture is worth a thousand words.” Similarly, providing sound along with associated text as the reader progresses through the text can allow an author to synergize the sound with different words so as to create a whole new set of creative possibilities, or to convey sense and meaning and subtle emotional feelings with fewer words.

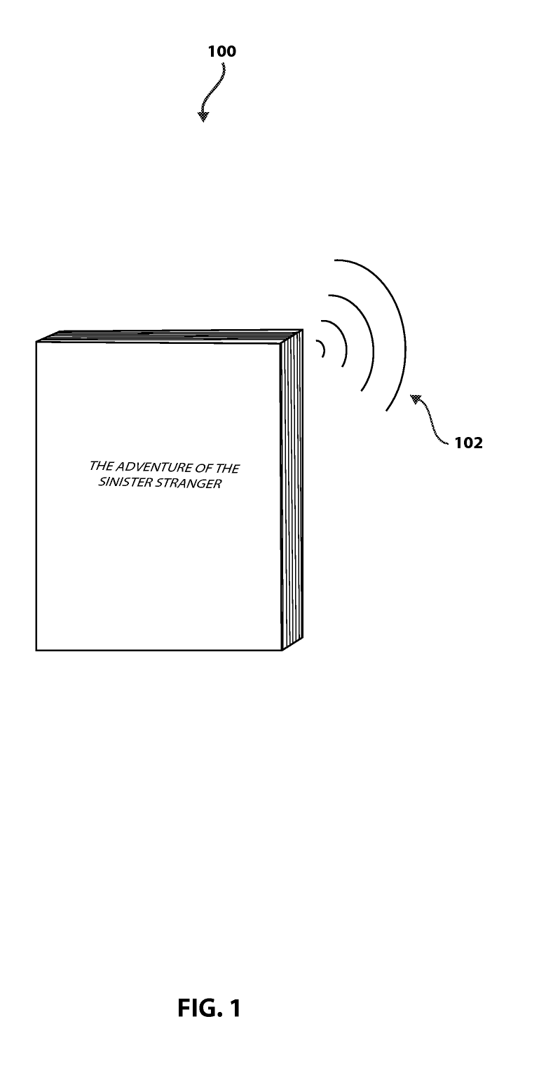

Referring to FIG. 1, one general aspect of the invention is an ebook 100 augmented with sound 102, such that the sound 102 is triggered by reader progress through the ebook 100, so that particular sounds 102 are automatically and selectively played so as to enhance the impact of particular text of the ebook 100 as it is being read by the reader. Some sounds 102 are played depending on the speed at which the text is being read. Some sounds 102 are played for a shorter time when the reader is reading fast, and some sounds 102 are not played at all when the reader is reading fast. Some sounds 102 are played for a longer time when a reader is reading slowly, and some sounds 102 are only played when the reader is reading slowly. Interruption of reading does not necessarily stop the sound 102, and resumption of reading does not necessarily start the playing of any sound. How this functionality is accomplished will be explained in detail further below.

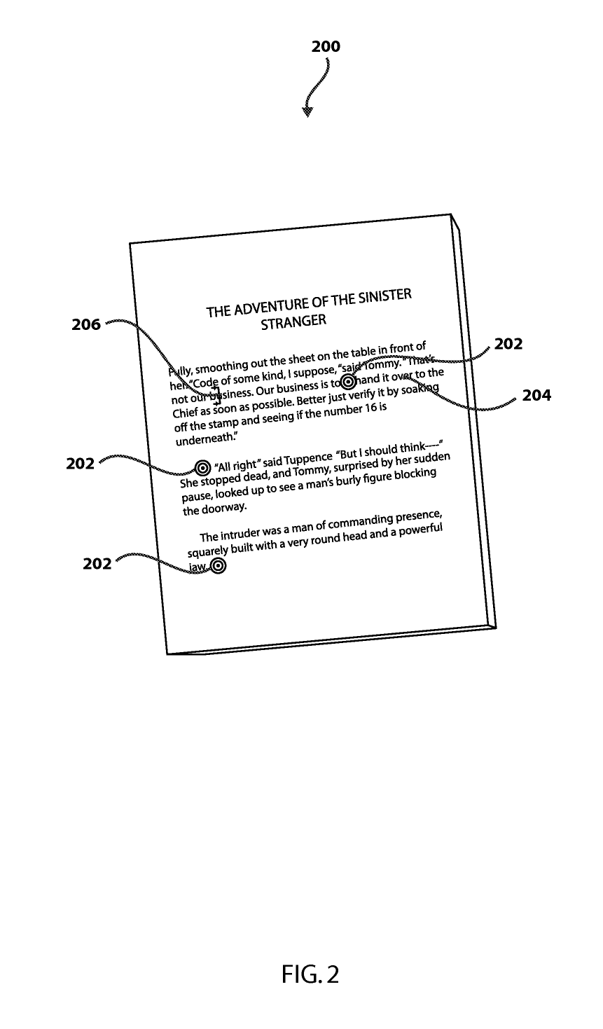

Referring to FIG. 2, a page 200 of the ebook 100 of the invention includes sound events 202 that are associated with particular text 204 of the page 200 of the ebook 100, so that when the reader is reading that text 204, as indicated by a reader progress position 206 (shown here using a selectably visible moving cursor 206), particular sound 102 is presented to enhance the effect of reading that text 204. Consequently, the experience of reading fictional works, such as novels, short stories, and plays, for example, is substantially enriched. Written non-fiction works, such as biographies, text books, creative non-fiction, written travelogues, magazines, newspapers, and picture books, can also be so-enhanced by adding sound paced by the reader's progress, according to the invention.

Thus, a general aspect of the invention is an ebook 100 having at least text information 204 with coordinated sound information 202, the coordinated sound information 202 being presentable in accordance with a reader's progress 206 through the ebook 100 so as to enhance the readers experience of reading the text information 204.

Graphical information (not shown), such as photographs, drawings, paintings, cartoons, etc can also be included with the text 204. Unlike graphical information that can be accessed by clicking on a hyperlink, the graphical information can be presented or hidden when the reader progress cursor 206 reaches an associated text string. For example, if a reader is reading fast, a picture can disappear if the reading speed exceeds a certain speed threshold. Or, if the reader is reading slower than a reading speed threshold, images will become viewable that would not be viewable to a faster reader. Also, a still picture can appear only when the reader progress point 206 is approaching within a word count radius of the text associated with the still picture, and for a short while after the reader progress point 206 is moving away from the text associated with the still picture. For example, the picture can appear when the reader progress point is within 40 words of the text associated with the picture, and can disappear from view when the reader progress point goes beyond 40 words from the text associated with the picture.

Further, video (with or without sound) can also be associated and presented with the text of the ebook (a feature not possible in books made of paper, but certainly possible and desirable in an electronic book). For example, a video can be represented by a silent still picture until the reader progress point 206 reaches the text associated with the video. Then, the still picture begins to move as a full-motion video with or without sound until the video plays to its end, whereupon the reader continues reading, and the reader progress cursor resumes moving at the latest computed reading rate. The reading progress cursor pauses while the reader is viewing the video.

Also, a still picture can have sound associated with it that can be triggered when the reader progress point reaches the picture, and then plays for some period of time, as can be determined by the author and/or ebook sound producer.

Sprites are typically used for characters and other moving objects in video games. They have also been used for computer mouse pointers. For on-screen moving objects larger than one sprite's extent, sprites may sometimes be scaled and/or combined. A sprite graphical layer can be superimposed upon the ebook text, graphics, and video of an ebook such that sprites can move over an entire page (or pair of pages) of an ebook. According to the invention, a sprite is initiated when the reader progress point reaches text (such as a word, or a plurality of words) that is associated with the sprite. The sprite can persist for a period of time that may or may not depend on the reading speed. There can be music that plays along with the action of the sprite. Alternatively, the sprite can persist until the reader progress point reaches an associated end trigger. In addition to sound, the sprite can be animated, such that it changes its appearance as it moves. Such animation can be accomplished by cycling through a sequence of sprite frames, each frame being an image of an animation sequence.

The sprite can appear to originate from the word or phrase that it's associated with, or it can emerge from any other location on the ebook page, as determined by the designer and/or author of the ebook. For example, when the reader progress point reaches the word “rabbit” in a children's ebook, a sprite that looks like a rabbit can hop out of the word “rabbit” and playfully move about the page for some seconds, or some minutes. Or the rabbit can disappear into the word “hole” when the reader progress point reaches that word in the text. Another example could be a shooting star that streaks across the top of the page of the ebook when the reader progress point reaches the words “shooting star” in the middle of a page of the ebooks. The information about the sprite is associated with the start trigger, and with any sound that accompanies the motion of the sprite. Also associated therewith can be the duration of the sprite, and/or the text associated with the end trigger.

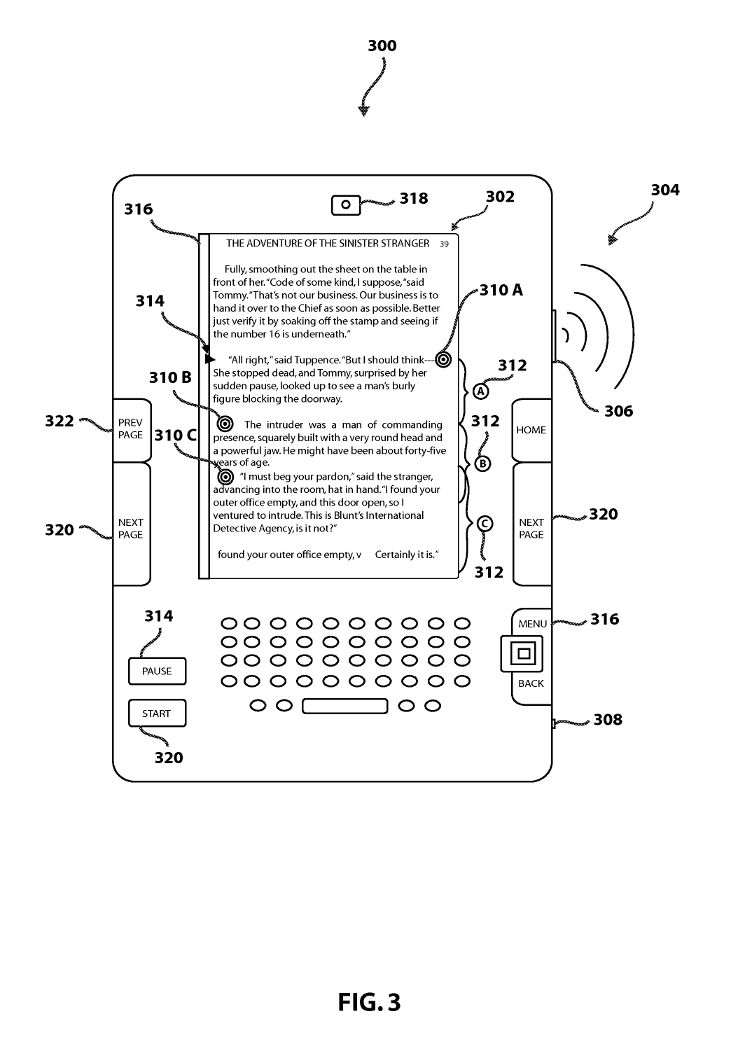

With reference to FIG. 3, another general aspect of the invention is an ebook presentation device 300 capable of presenting to a reader text information 302 (also 204) of an ebook 100 along with associated sound information 304 (same as 102), the associated sound information 304 being presented to the reader of the ebook 100 as a direct consequence of the reader making progress through the text information 302 (204) of the ebook.

The sound information 304 can be advantageously structured as at least one sound event file (such as an .mp3 or .wav file) having a plurality of sound events 310A, 310B, 310C (same as sound events 202 shown in FIG. 2) that are integrated and/or associated with the text and/or graphical content of the ebook. The sound information can be presented to the reader of the ebook via a built-in speaker 306, or via a headphone jack 308, or via a wireless connection (Bluetooth or WiFi) to a wireless speaker system or wireless stereo sound system, for example. Connection to a home theater system would help to create an immersive sound environment including sub-woofers that can be felt as well as heard while reading the associated text.

As a reader reads the ebook of the invention, at least one sound event 310 is presented as sound audible to the reader, along with a corresponding portion A 312 of the content of the ebook. The sound event 310 is triggered by passage of a reader progress point (not visible in FIG. 3) (sometimes indicated by a cursor 206 as in FIG. 2) that tracks or estimates where the reader is reading within the content of the ebook, such as where the reader is reading within a page 200 (or other presented portion) of the ebook 100 being presented to the reader. The location within the page can be a single location, or can be approximate, such as somewhere within a line of text, or somewhere within two or three lines of text, for example.

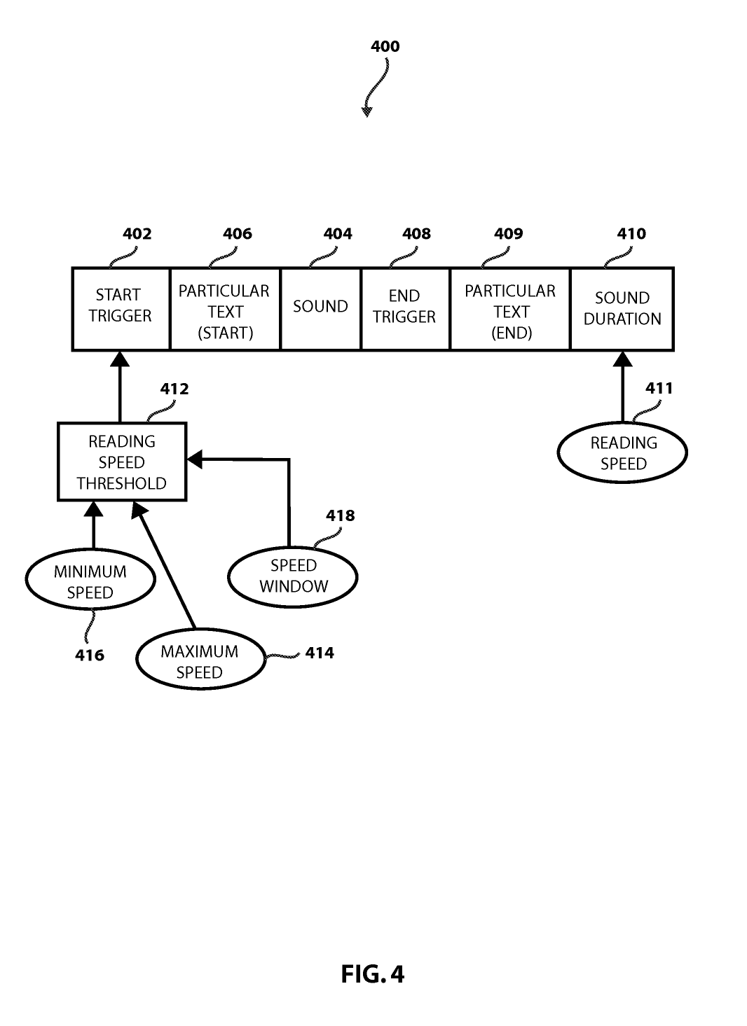

The reader progress point represents in real-time at least an estimate of where the reader is reading within a page (or other presented portion) of the ebook, and triggers the playing of a sound event when the reader progress point passes over a sound event trigger associated with a sound event that is embedded at a point within the content of the ebook, as will be explained with reference to FIG. 4.

The reader progress point can be indicated by a visible moving cursor 204 with the same location coordinates as the reader progress point, or the reader progress point can be invisible the reader as the reader progress point moves. In touch screen embodiments, the user can move the reader progress point to a new location as desired.

The location of the reader progress point can also be approximately indicated by a symbol 314 located along a vertical symbol display region 316, such that the symbol 314 can be moved automatically to the beginning of each successive line of text before it is read by the reader. The symbol can be a triangle, a dot, or a square, a line, or an arrow, for example. When a touch screen interface is available, the user can move the symbol up or down to change the location of the reader progress point.

Referring to FIG. 4, each sound event 400 (such as 310A) is associated with at least one start trigger 402 that initiates playing the sound 404 of the sound event 400 when the moving reader progress point 204 reaches the start trigger 402 associated with particular text 406 in the ebook. The particular text 406 has been identified by the author and/or sound composer of the ebook as being a suitable place in the ebook to interject the sound so as to enhance the reader's experience of reading the particular text 406, and a subsequent portion of the ebook.

There can be many sound events embedded within the content of an ebook, and each sound event plays independently of other sound events. For example, FIG. 3 show three sound events 310A, 310B, 310C associated with the text segments A, B, C 312 on a particular page of an ebook. Each sound event has a duration that can be a period of time between starting to play the sound 404 as initiated by the start trigger 402 and stopping playing the sound 404 as actuated by the end trigger 408. Alternatively, the sound can play as initiated by the start trigger 402, and play for so long as specified by an associated sound duration 410.

A sound event 400 can be played in either total or partial overlapping relationship with another sound event. For example, sound event 3108 overlaps with sound event 310C. A sound event also can be structured so as to either contain at least one other sound event, or be contained by another sound event. Triggering the start of a first sound event can, at some point in time (or some location in the text) during the duration of the sound, automatically trigger the start of a second sound event. If the first sound event is not triggered, then the contained second sound event is not triggered.

One way that a sound event may not be triggered is if the reading speed is not accepted by a reading speed threshold module 412. For example, a sound event may not be triggered if the reader is reading so fast that there's not enough time for the sound to be played in its entirety, and therefore might best not be played at all. So, if the reading speed is higher than a maximum speed 414, some sound events will not play because their triggering will be suppressed by the reading speed threshold. Examples of such sounds include certain mood sound effects that require a certain minimum amount of time to convey the mood.

It's also possible that if the reader is reading too slowly, a sound event may not trigger. For example, if a sound is designed to be played during high speed reading, such a sound event would NOT trigger when the reader progress point passes over the start trigger slower than a minimum reading speed threshold 416. For example, short-duration sounds can be selected to convey sonic contexts for events that enhance the reader's sense of place, such as fog horns or sea bird cries near the sea, whereas a slower reader would be exposed to more elaborate sounds of a seaport.

Another situation can occur when the reading speed must be within a certain speed window 418. In this case, if the reading speed is slower or faster than the window limits, the sound event will not trigger.

Another aspect of a sound event that depends on reading speed is how long a sound will play, such as how long an environmental sound, or a musical selection will play, for example. So, if the sound event does NOT end based on the reader reaching a particular point in the text of the ebook, it can instead end based on a specified sound duration 410. The sound duration 410 can depend on the reader's speed 411.

A sound dependent upon speed can depend on the speed in a variety of ways. For example, if a sound has an identifiable beginning, middle, and end, the beginning and end of the sound can be the same regardless of reading speed, and the middle of the sound can have a duration that depends on the reading speed. In fact, the middle of the sound can be suppressed entirely if the reading speed exceeds a fast reading threshold. Or, the sound can have a beginning with a duration that depends on reading speed, a middle that is independent of speed, and an end that plays only if the speed falls below a certain slow reading speed threshold, or example.

Speed triggering can also occur within defined sound ranges. For example, sound ranges can include a slow, medium, and fast reading speed range. Some sounds may play only when the reading speed falls within the slow range, while others may play only when the reading speed falls within the medium range, and yet others will play only when the reading speed falls within the fast range.

It is also possible to enable the reader to set the level of sound enhancement of the text information. For example, a reader may find that the number of sounds injected into the reading experience is distracting, preferring to hear only shorter sounds, or only environmental sounds, for example. Or, the reader may prefer to hear all of the sounds included by the author and/or sound producer of the ebook with sound paced by reader progress. The reader can select the level of sound enhancement to: minimal, reduced, or full, for example. Or the user can select the type of sound enhancement: only music, only environmental, or only sound effects, only music and sound effects, for example.

A reader can create his/her own sound events to be associated with text selected by the reader. Thereafter, whenever the reader reads that selected text (i.e., whenever the reader progress point traverses the start trigger associated with that text), the sound event created by the reader and associated with that text will be played. Such a sound event can be a voice note recorded by the reader, or can be an alarm or alert sound selected from a set of available pre-recorded sounds. This feature can allow a reader to remember thoughts or feelings from a previous reading of the ebook, or to record important related information and associate that information with the selected text. Or, this feature allows the reader to create a “sonic bookmark”. Additionally, the location of the voice note within the text can be graphically indicated by an icon, such as a “note pad” symbol near the text. Touching or dwelling upon the symbol can initiate playing of the sound.

A reader's speed can be calculated by timing the interval between page turns. An updated estimate of reader speed can be calculated with each additional page turn event. If reading speed is calculated for the user of the ebook presentation device using a reading sample, the reader progress point can begin moving as soon as the reader somehow indicates that reading has begun, such as by pressing a “reading start” button, or by saying “START” or “BEGIN” to a voice recognition system built into the device. Alternatively, reading is presumed to have begun with the first page turn, and the reading speed used is the reading speed calculated using the reading sample. With the second and subsequent page turns, the reading speed can be automatically adjusted. The reading speed can also be manually set or changed by the reader.

Reading speed information is obtained during a preliminary calibration step by measuring a reader's personal reading speed, i.e., the rate at which the reader typically reads, best expressed in units of words per minute, words per second, pages per minute, or pages per hour. The reader's personal reading speed can be measured by giving the reader a test consisting of reading a known number of words (or a known number of pages having a known average number of words per page), and measuring the time the reader takes to read the known number of words or pages. The reader's personal reading speed is computed by dividing the known number of words (or pages) by the time measured to read them. The reader's speed can be manually adjusted by the reader, if the reader prefers a pace other than what was measured. Alternatively, the reader's speed can be automatically adjusted as the reader reads by continuously measuring the amount of time between page turns.

Once reading speed is known, the position of the reader progress point can be computed using a timer, and multiplying the time by the reading speed to get an approximation of where the reader is reading within the current page (or pair of pages). The timer is reset to zero and re-starts upon each page turn event.

It is also possible to determine the position of the reader progress point by using an eye tracking device, such as an EYE GAZE TRACKING SYSTEM from EyeTech Digital Systems, Mesa, Ariz. Such a system can be used with, or incorporated into, the ebook presentation device of the invention. The eye gaze tracking system would simply determine where the reader is reading by detecting the location of gaze upon the page of the ebook presentation device. If the reader's eyes tend to dart about rapidly, a moving average location of gaze can be computed, and a text bubble can be created around that moving average location to represent the reader progress point that moves forward only when the moving average position moves forward. The reader progress point can be located at the center of the text bubble, or at the lower right corner of the bubble, or at a point settable by the reader therebetween. Gaze locations that are behind the moving average text bubble and are brief (e.g., a few seconds) are not included in the computation of the moving average text bubble. Gaze locations that are behind the moving average text bubble and are longer in duration (e.g., more than ten seconds) will result in replacing the moving average with a new moving average position behind the old moving average position.

Alternatively, eyetracking can be simulated using a touch screen interface. The reader touches the place where the reader is reading, and scans the reader's finger across the words of text in each line as the reader reads. The place touched on the screen is understood to be the reader progress point 206. The place touched can be indicated by a vertical line, or an underline, or other cursor symbol.

Alternatively, in a whole-line mode, when the reader touches the screen, the entire line of text that includes the point touched by the reader is included within an “active text area”. The reader moves his/her finger vertically through the text, or vertically alongside the text, while maintaining continuous finger contact with the touch screen. The reader progress point 206 position is estimated using a timer output multiplied by the reading speed.

The active text area boundary can be invisible, or can be indicated by a change in brightness, or a change in focus, or a change in color. The line of text that includes the point touched can be underlined, or made bold, or be of a different color than neighboring lines of text.

The active text area can also be outlined with a fine black line, or a bold black line. Of course the black line can also be colored bold red instead of black, or the line can be any other high contrast color.

The active text area boundary completely surrounds at least one line of text, although the active text area can also contain more lines of text as selected by the reader. The shape of the boundary is preferably a rectangle with rounded corners, but an ellipsoidal or hot-dog shape, or any other shape that completely surround at least one line of text would be effective.

The text inside the active text area can be made brighter, and/or the text outside the text bubble can be made softer, blurrier, and or darker. The active text area can be tinted so that inside the active text area, the background color is a color other than white, such as pale blue, or pale purple, for example. The background color outside the active text area remains white, or vice versa. Preferably, the active text area includes a line or two of text above and below the line of text being touched.

Particular text inside the active text area can be tapped to obtain a definition and/or a synonym of the text word tapped or dwelled upon with a finger. Tapping or dwelling upon a citation superscript can be done to access a citation associated with a string of text, for example. Also, tapping a word within the active text area, or dwelling upon a word with a continuous finger touch within the active text area can provide a translation of the word. Double tapping any place within the active text area can provide a translation of the text within the active text area into a reader-selected foreign language. English-as-a-second-language readers can obtain the English translation of any text in their primary language, and with a triple tap, the English text can be automatically read out-loud with proper pronunciation by a text-to-speech synthesizer.

Another way to obtain reader progress point position information is by using touch screen input, wherein a reader manually indicates a page number and position within the page of what is currently being read by touching a point within a selected page. The page number and position within the page can be used, along with reading speed information and timer information, to estimate (or more correctly estimate) reader progress point position for times after the touching of the point on the selected page. Touching a page can also provide an indication to the reader of the page number of the page touched, as well as a location within the page touched.

Still another way to obtain reader progress cursor position information is to detect sound information from the reader using a microphone or other sound detector built into or attached to the ebook reader or computer, where the sound information indicates when the reader starts reading a page and/or completes reading a page. The reader can generate the sound information by vocalizing, such as by saying “start”, “end”, or “next”, or by stating the current page number. The reader could also generate sound information by tapping, such as by tapping twice or three times to indicate that the reader has commenced reading a new page. For example, the reader can tap on an iPhone or iPad, which would detect the tapping with a built-in microphone, or with the touch screen, and display current page number, and play the corresponding portion of the sound file for that page, or for a computed position within that page.

Another way to obtain reader progress cursor position information is to detect page turn events of a real book with real paper pages, using a vibration/sound sensor (connected to a computer via USB or Bluetooth, for example) that is attachable to (or insertable within) the spine of the book. The vibration/sound sensor can also be clipped to a cover of the book. The computer receives the page turn event signals from the vibration/sound sensor, and uses that information to compute reader position information within the text of the book, which is inturn used to trigger sound events. The vibration/sound detector, and the computer software description are described in co-pending patent application entitled PAGE TURN DETECTOR FOR USE WITH BOOKS ENHANCED WITH SOUND EVENTS TRIGGERED BY READER PROGRESS. According to this invention, a sound event file that is coordinated with the content of the book with paper pages can enhance a reader's experience of reading the content of the book. A portion of the sound event file is presented along with a corresponding portion of the content of the book in accordance with reader progress point position information.

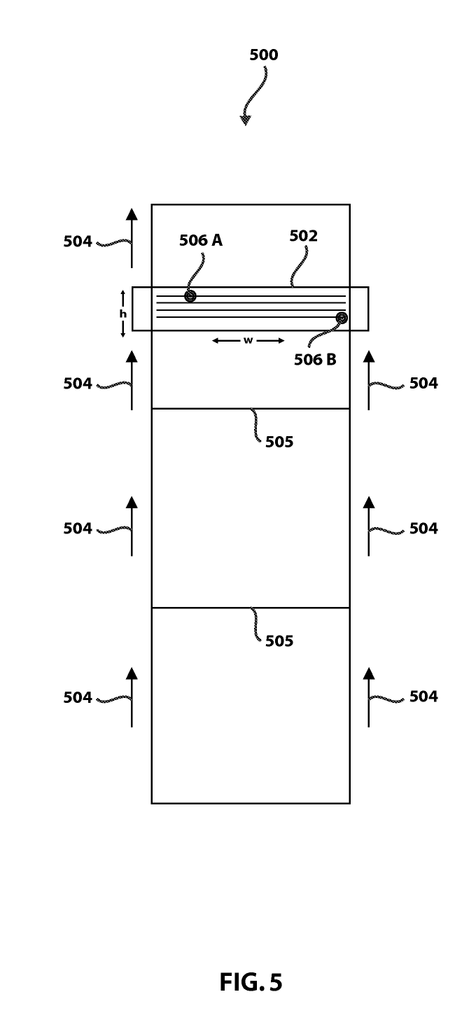

Referring to FIG. 5, in another important aspect of the invention, ebook content 500 is “streamed” via a text streaming window 502 at a rate 504 set by the reader in accordance with his/her preference. Pages of text are indicated by page breaks 505. The height ‘h’ and width ‘w’ of the text streaming window 502 can also be set by the user according to preference. The window 502 can be one, two, three, four, or five lines of text, for example.

The sound events 506A and 506B associated with the text streaming through the window 503 are triggered by the current reader progress point position, which can be computed using the location of the text streaming window within the ebook, such as by using the location of the center of the text streaming window. This embodiment enables relatively accurate determination of the position of the current reader progress point, resulting in more correct timing of the triggering of sound events.

To recap, a sound event file according to the invention is a file that contains a plurality of sound events, each sound event corresponding to content, such as text or graphics or video, within an ebook. Each sound event is associated with or includes a start trigger that is embedded at (or associated with) a position within the content of the ebook. When the reader progress point position reaches the start trigger, the sound event starts playing until either a sound duration elapses, or until an end trigger of the sound event embedded at a subsequent position within the ebook is reached by the reader progress point, i.e., the reader progress point position within the text momentarily equals the position of the corresponding content of the end trigger. Thus, a sound event also includes (or is associated with) an end trigger or a sound event duration, either of which determining when the sound event is to stop playing.

The sound event duration of a sound event can depend on reading speed, such that a sound event triggered by a relatively fast-moving reader progress point can have a lesser sound event duration than a sound event triggered by a relatively slow-moving reader progress point.

Thus, since a slower reader makes slower progress through the content of an ebook (or book), there is more time to fill with sounds that are coordinated with the content of the ebook, such as music, sound effects, and ambience sounds, for example. Consequently, each sound event can have a longer duration, and/or there can be more sound events to be experienced by a slower reader.

After a period of reading, a reader of an ebook with reader-paced sound will want to take a break from reading, or will need to interrupt reading. To maintain the proper correlation between the content of the ebook and the coordinated sound, the ebook presentation device must be informed that a break in reading is to be taken. This can be accomplished either by the user pressing a PAUSE button 314 of the ebook presentation device 300 of FIG. 3, or the user selecting and pressing a menu item 316 of the ebook presentation device user interface, or the user pressing a portion of the touch screen of the ebook presentation device, for example. Alternatively, a camera 318 facing the reader of the ebook presentation device 300, or of a computer running software that performs the functions of the ebook presentation device 300, including “eye tracking,” can detect both eye movements related to reading, and the cessation of such eye movements, and thereby automatically detect when a reader has stopped reading.

Another way to automatically detect when a reader has stopped reading involves using the camera 318 of the ebook presentation device 300 to detect the departure of the face of a reader from the field of view of the camera 318. Further information regarding whether the reader is reading can be gained by also determining the orientation of the face of the reader.

Conversely, after taking a break from reading, a reader of an ebook with sound events triggered by reader progress will want to resume reading, or will need to start reading (again) after the ebook of the invention has been turned off and then turned on again. To maintain the proper correlation between the content of the ebook and the coordinated sound, the ebook presentation device must be informed that reading is to begin (or resume). This can be accomplished either by the user pressing a start button 320 of the ebook presentation device 300 to indicate that reading has begun, or by the user selecting and pressing a menu item 316 of the ebook presentation device, or by the user pressing a portion of the touch screen of the ebook presentation device, for example. Alternatively, a camera facing the reader of the ebook presentation device can be used to detect eye movements related to reading, and the pattern of such eye movements that indicates that the reader has started reading.

Another way to automatically detect when a reader has started reading involves using the camera to detect the arrival (or return) of the face of a reader into the field of view of the camera of the ebook presentation device. Further information regarding whether the reader has started reading can be gained by also determining the orientation of the face of the reader.

Sound events can be categorized by duration. For example, short sound events include door slamming, thunder, dog bark, etc, and longer sound events include music, and ambience sounds (crickets, rain, heartbeats, breathing, synthesizer, etc).

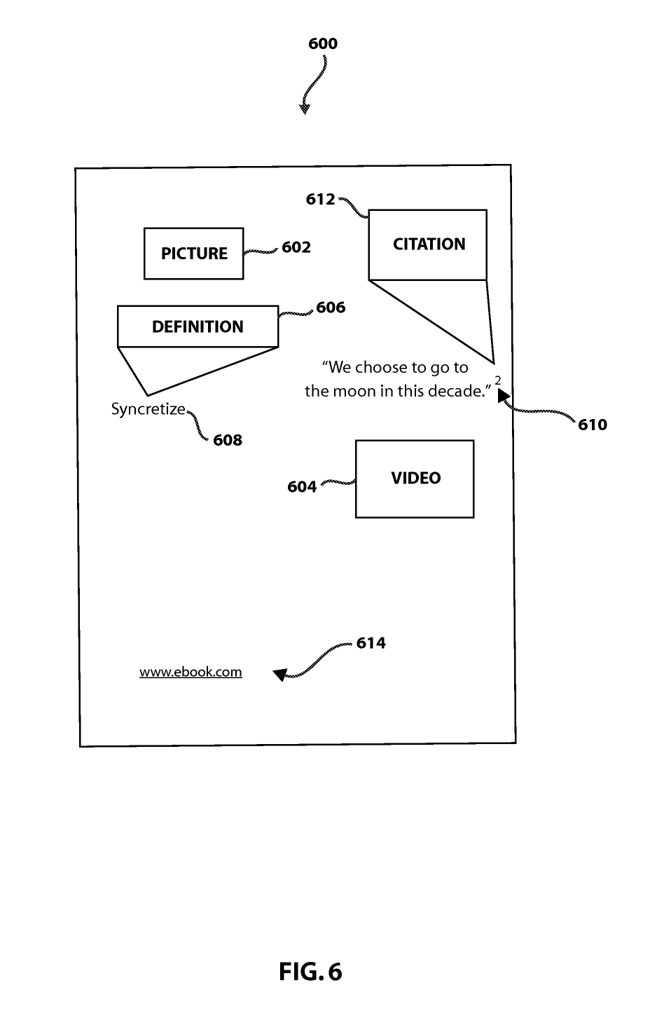

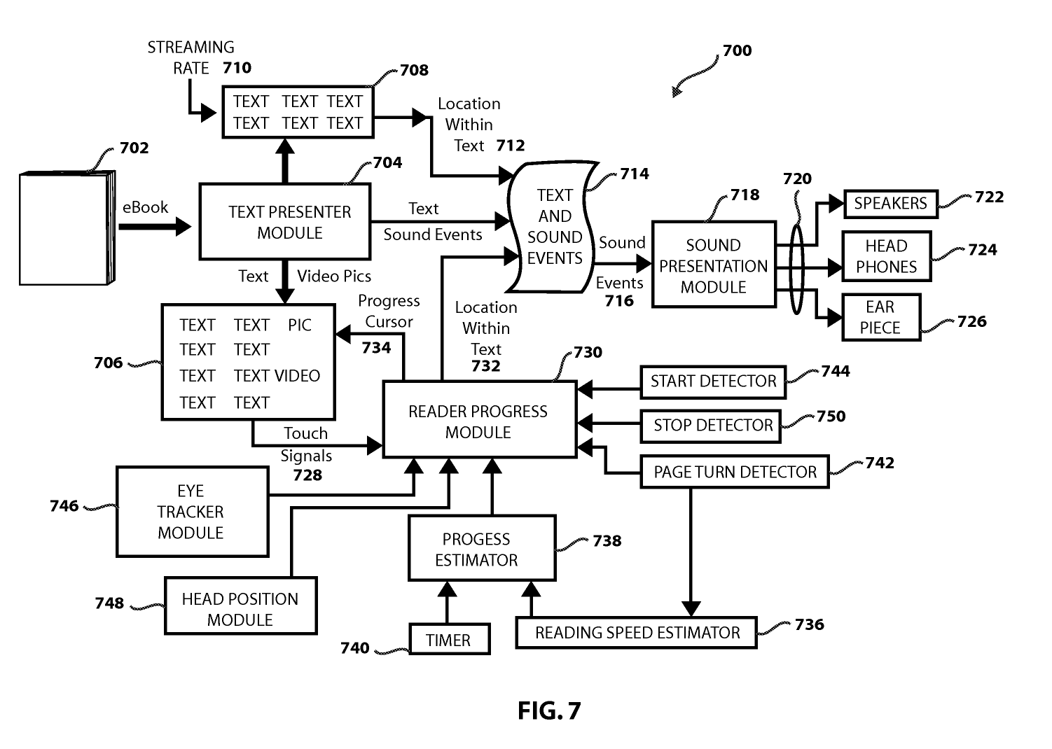

Referring to FIG. 6, sound events typically are created and included to enhance a reader's experience while reading text, but they can also accompany viewing a picture 602 embedded within the text of an ebook page 600. The reader could touch the picture 602 presented via a touch screen to indicate that the picture 602 is being viewed, and a sound event associated with the picture 602 would play. This would also have the effect of automatically pausing the progress of the reader progress point, as well as providing the reader progress module (730 in FIG. 7) with additional information as to the location of the reader progress point. Touching the picture 602 when one is done viewing the picture 602 would have the effect of resuming progress of the reader progress point, as the reader also resumes reading.

Alternatively, if an eye-tracking module is included in the ebook reader, a sound event would play when the eye-tracking module detected that the reader was viewing the picture 602. The sound event could be music to enhance viewing of the picture 602, or a person's voice explaining the content of the picture 602, or both, for example. When the reader returned to reading the text, the reader progress point would also resume moving forward.

Use of an eye-tracking module also enables a video 604 to be played (with or without sound) whenever the eye-tracking module detects that the reader is looking at the video 604. During such times, the progress of the reader progress point is automatically paused. When the eye-tracking module detects that the reader is NOT looking at the video 604, the video 604 does not play, instead presenting a still picture representing the video 604. The still picture is not as distracting as a full-motion video to the reader of the ebook while he/she is reading text.

Use of an eye-tracking module also enables the useful functionality of allowing a reader to access the pop-up definition 606 of a word 608 simply by staring at the word 608 (also called “dwelling”) for a few seconds (settable by the user) to pause the reader progress point and to cause a definition of that word 608 to appear in a pop-up window 606. The pop-up window 606 disappears after a settable time, such as 15 seconds. Alternatively, touching the word 608 can also result in providing a pop-up window 606 with the definition or synonym (selectable by the reader) of the word contained therein, also thereby pausing progress of the reader progress point. Touching the pop-up definition 606 removes the pop-up definition 606 and resumes progress of the reader progress point. The pop-up definition 606 functionality can be used to enhance learning English as a Second Language, or to enhance learning any second language for the first time, or to facilitate learning to read for the first time.

Another related feature that uses eye-tracking software is dwelling on a super-script 610 of a citation in the text of an ebook to get the citation to appear in a pop-up window 612 over the text of the ebook. Alternatively, touching the super-script 610 of the citation will cause the citation to appear in a pop-up window 612 over the text of the ebook.

Use of an eye-tracking module also enables a reader to visually dwell on a hyperlink 614 embedded in the text of an ebook, and thereby open the hyperlink to reveal the text associated with that hyperlink. The hyperlink 614 can be graphically associated with a string of text, such as by the usual convention of underlining text and displaying it in blue. The hyperlink 614 could take the reader to another portion of the text of the ebook, or in embodiments with an internet connection, take the reader to another source of information on the Web. Touching the hyperlink 614 in a device having a touch screen would effectively function the same way.

A hyperlink 614 activated by visually dwelling on the hyperlink (or by touching the hyperlink), as detected by an eye-tracking module (or touch screen), can be called a “visual rabbit hole”. For example, the text “dwell (touch) here for more information” could be used to enable the reader to stop reading the ebook, and start reading an article referred to by the ebook.

Alternatively, dwelling on the hyperlink 614, or touching it via a touch-screen, could initiate the playing of a video clip.

Touching or dwelling on a “visual rabbit hole” can result in providing the reader with additional information related somehow to the neighboring text. The additional information is provided at a level selectable by the reader. The reader can select a global default level, so that just dwelling upon (or touching) the visual rabbit hole will result in additional information at the level selected.

Further, if the reader wants the information in a particular visual rabbit hole to provide additional information at a level different from the selected global level, the reader can select a local level for that particular visual rabbit hole. This is done by either dwelling for an extended period upon the visual rabbit hole so as to bring up a pop-up menu that provides other level choices, or by touching three times so as to bring up a pop-up menu that provides other level choices.

The level choices can represent different levels of difficulty, different levels of detail, or different amounts of supplementary information. For example, the reader can select from “easy”, “medium”, “hard” reading levels. Or, the user can select from “brief summary”, “summary with some details”, and “full details”. The reader can always reset a global default setting so that the information presented in the visual rabbit hole links will be presented at that new set level.

Links that can be activated by visually dwelling upon them can be advantageously indicated by italicized text, since the word “italicized” includes the same phoneme as the word “eye”, which suggests that one's eyes can open the link.

Referring to FIG. 7, an embodiment of an ebook presenter 700 for presenting an ebook 702 of the invention to a reader along with coordinated sound events incorporated within the ebook is described. The sound events are presented to the reader as the reader progresses through the text of the ebook.

The ebook 702 includes text and sound events, as described above with reference to FIGS. 2 and 4. A text presenter module 704 receives the ebook 702, and presents the text (and possibly also any pictures, graphics, and/or video) on a display screen 706 that can display an entire page (or pair of entire pages) at one time. The reader presses a next page button 320 or previous page button 322 (see FIG. 3) to page forwards and backwards through the text of the ebook.

In an alternate embodiment, the text of the ebook 702 can be presented via a text streaming window 708 that presents one, two, three, four, or five lines of text at a time. The reader can adjust the streaming rate 710 to control the rate at which text is presented to the reader. The reader sets a streaming rate 710 that is comfortable, i.e., a rate that matches the reading speed of the reader. In this embodiment, the location within the text 712 of the ebook that is being read by the reader is known to be within the text streaming window 708. Consequently, since a sound event is played when the reader progress point reaches the text associated with the sound event 714, sound events 716 start playing via the sound presentation module 718 when the text associated therewith is within the window 708.

The sound presentation module 718 puts out sound signals 720 that can be made audible to the reader via speakers 722, head phones 724, or an ear piece 726, for example.

Returning to the embodiment employing a full text display screen 706 (such as the text display screen 302 in FIG. 3), the display screen 706 can be a touch screen display which can provide touch signals 728 that provide information as to where the reader has touched the screen, such as where within the text of a page of the ebook the reader has touched. In other embodiments, the reader can just point and click using a pointing device, such as a mouse or a touch pad.

The touch signals 728 are used by a reader progress module 730 to provide the location within the text 732 so as to determine which associated sound event 716 associated with the text being read 714 is ready to play via the sound presentation module 718.

The reader progress module 730 can also display a reader progress cursor 734 if the reader desires to display where the ebook presenter 700 believes the reader to be reading. If the location within the text 732 as shown by the progress cursor 734 is not true to the actual place within the text that the reader is reading, the reader can touch the touch screen 706 where the reader is actually reading. Alternatively, the reader can adjust the stored estimate of the reading speed as calculated and stored by the reading speed estimator 736.

The reading speed estimator 736 provides an estimate of reading speed to the progress estimator 738. The progress estimator 738 uses the reading speed estimate and time information provided by a timer 740 to calculate an estimated location within the text 732 where the reader is most likely reading.

The reading speed estimator 736 is informed by the page turn detector 742 each time a page (or pair of pages) is turned. The page turn rate can be used to calculate the reading rate by knowing how many words fit into a page, on average. The number of words per page is a function of the display font size that can be selected by the reader.

The location within the text 732 is also determined by when a reader starts reading, when the reader pauses reading, and when the reader stops reading. For example, the start detector 744 detects when the reader has started reading, either by detecting the first page turn event, or by receiving signals (not shown) from an eye tracker module 746, or by receiving signals (not shown) from a head position module 748 that detects when a reader's head is first oriented so as to be ready to commence reading, or by hearing a voice command to “start”.

Conversely, the stop detector 750 detects when the reader has stopped reading, either by detecting a cessation of page turn events, or by receiving signals (not shown) from an eye tracker module 746, or by receiving signals (not shown) from a head position module 748 that detects when a reader's head is no longer oriented so as to be able to read, or by hearing a voice command to “stop”.

Other modifications and implementations will occur to those skilled in the art without departing from the spirit and the scope of the invention as claimed. Accordingly, the above description is not intended to limit the invention, except as indicated in the following claims.

What is claimed is:

1. A sound-enhanced ebook, the sound being presentable to a reader of the ebook in accordance with the reader's progress through the ebook, the sound-enhanced ebook comprising:
text information; and
a plurality of sound events,
each sound event being associated with particular text of the text information,
each sound event being presentable in response to a reader's progress through the text information.

2. The sound-enhanced ebook of claim 1, wherein each sound event is associated with at least one start trigger that starts playing the sound event when the reader's progress reaches text associated with the start trigger.

3. The sound-enhanced ebook of claim 2, wherein the start trigger depends on a speed of the reader's progress through the text information, the start trigger playing an associated sound event only if the speed is less than a speed threshold of the start trigger.

4. The sound-enhanced ebook of claim 1, wherein each sound event is associated with an end trigger that ends playing of the sound event when the reader's progress reaches text associated with the end trigger.

5. The sound-enhanced ebook of claim 1, wherein each sound event is associated with a sound duration.

6. The sound-enhanced ebook of claim 5, wherein the sound duration depends on a speed of the reader's progress through the text information.

7. The sound-enhanced ebook of claim 1, wherein the reader's progress through the text information is represented by a point moving through the text information, the approximate position of the point being calculated using a computation of the reader's reading speed, and an output of a timer.

8. The sound-enhanced ebook of claim 1, wherein the reader's progress through the text information is determined using an eye-tracking device.

9. The sound-enhanced ebook of claim 1, further including at least one of:
graphical information;
sprite information;
animation information;
video information;
hypertext information;
definition information
synonym information;
translation information; and
citation information.

10. An ebook presenter for presenting content of an ebook to a reader along with coordinated sound events, the sound events being presented as the reader progresses through the ebook, the ebook presentation device comprising:
a text presenter module capable of presenting at least text information of an ebook via a display;
a reader progress module capable of determining at least an estimate of the reader's progress through the text information of the ebook; and
a sound presentation module capable of playing sound events via a sound generator,
each sound event being associated with particular text information of the ebook,
each sound event being presentable in response to the reader's progress through the text information of the ebook as at least estimated by the reader progress module.

11. The ebook presenter of claim 10, wherein the reader progress module receives information from an eye-tracking device.

12. The ebook presenter of claim 10, wherein the reader progress module receives signals from at least one of:
a reading start detector;
a reading stop detector;
a reader progress estimator;
a touch screen;
an eye tracker module; and
a page turn detector.

13. The ebook presenter of claim 12, wherein the reader progress module further provides a selectably visible reader progress cursor.

14. The ebook presenter of claim 10, wherein the reader progress module receives signals from a reader progress estimator,
the reader progress estimator determining at least an estimate of the reader's progress through the text information of the ebook using a timer and at least an estimate of the reader's reading speed.

15. The ebook presenter of claim 14, wherein the estimate of the reader's reading speed is recalculated after each page-turn event.

16. The ebook presenter of claim 10, wherein the sound presentation module can play a sound event in response to the reader's progress reaching a start trigger of the sound event.

17. The ebook presenter of claim 16, wherein the sound presentation module stops playing the sound event in response to the reader's progress reaching an end trigger.

18. The ebook presenter of claim 16, wherein the sound presentation module stops playing the sound event in response to the sound event playing for a period of time at least as long as a sound duration of the sound event.

19. The ebook presenter of claim 10, wherein the reader progress module can receive input from a touch screen allowing a reader to touch an ebook page at a particular position to indicate at least one of:
where within the text reading is presently occurring;
where within the text reading is to commence;
where within the text reading is to pause;
where within the text reading is to stop; and
at least approximately which line of text is being read by the reader.

20. The ebook presenter of claim 10, wherein the reader progress module is capable of determining a reader's personal reading pace during a preliminary calibration step by measuring how long it takes for the reader to read a known reading sample.

21. The ebook presenter of claim 10, wherein the reader progress module computes an estimated current progress position within a page using page turn rate information and timer information.

22. An ebook presentation device for presenting content of an ebook to a reader along with coordinated sound events, the sound events being presented as the reader progresses through the ebook, the ebook presentation device comprising:
a text presenter module capable of presenting text information of an ebook to a reader by streaming the ebook content via a text streaming window; and
a sound presentation module capable of playing sound events,
each sound event being associated with particular text of the text information of the ebook,
each sound event starting to play while inside the text streaming window.

23. The ebook presenter of claim 22, wherein the height and width of the text streaming window can be set by the user according to preference.

24. The ebook presenter of claim 22, wherein a rate of text streaming is settable by the reader.

25. The ebook presenter of claim 24, wherein the sound event duration of a sound event can depend on the rate of text streaming, such that a sound event triggered during a rapid rate of text streaming has a shorter sound event duration than a sound event triggered during a slow rate of text streaming.
